(19) United States
(12) Patent Application Publication
(10) Pub. No.: US 2015/0290548 A1
(43) Pub. Date: Oct. 15, 2015

(54) TOY MESSAGING SYSTEM

(71) Applicant: Mark Meyers, Thousand Oaks, CA (US)

(72) Inventor: Mark Meyers, Thousand Oaks, CA (US)

(21) Appl. No.: 14/682,289

(22) Filed: Apr. 9, 2015

Related U.S. Application Data
(60) Provisional application No. 61/977,499, filed on Apr. 9, 2014.
(60) Provisional application No. 61/977,522, filed on Apr. 9, 2014.

(51) Int. Cl. A63H 3/28; H04B 5/00; H04W 4/00

(52) U.S. Cl. CPC A63H 3/28; H04W 4/008; H04B 5/0031

(57) ABSTRACT

A toy includes a data-receiving device such as a Bluetooth radio, for receiving data from a mobile device within range of the radio. A system for providing data communication between a remote device and a toy comprises a toy having a data-receiving device, a mobile device and a remote server. The server receives a message from the remote device and transmits the message to the mobile device, which in turn, transmits the message to the data-receiving device of the toy.

### CROSS REFERENCE TO RELATED APPLICATIONS

The application claims the benefit of U.S. Provisional Application Nos. 61/977,499 and 61/977,522, both filed on Apr. 9, 2014, which are incorporated by reference herein in their entirety.

### FIELD OF INVENTION

The invention is related to a toy and a system for relaying messages.

### BACKGROUND OF THE INVENTION

The invention relates generally to a toy, such as a plush doll, and a system in which the toy wirelessly receives a message from a mobile device.

Dolls currently exist having a port for receiving a cable, such as a USB (universal serial bus) cable to connect the doll to a computer. A user may use software on the computer to transfer files onto the doll. It may be cumbersome to connect the doll to the computer each time to transfer a file, and it may be even more cumbersome if the file exists on a different device, which must be transferred to the computer, before being transferred to the doll.

Accordingly, it is desirable to provide an improved system and toy for transferring files to a toy that overcomes drawbacks and inadequacies of known toys and systems.

### SUMMARY OF THE INVENTIONS

The present invention is directed to a doll capable of receiving data such as an audio file from a mobile device. One embodiment of the doll comprises a Bluetooth radio for wirelessly receiving the audio file from the mobile device. The doll preferably also includes a storage medium for storing the audio file, an activator for playing the audio file and a speaker via which the audio file may be heard. Preferably, the doll is a plush doll.

An embodiment of the invention is also directed toward a system having a server onto which a person may upload a file, such as an audio file containing a message. The audio file is transmitted from the server to a mobile device, which in turn transmits the audio file wirelessly to a doll having a speaker. The doll includes a Bluetooth radio for receiving the audio file wirelessly, and a button which may be pressed to play the message.

In accordance with another embodiment of the invention, the doll is constructed and arranged to receive and play image files and/or video files. The doll may also include a camera for capturing still or moving images, more specifically, photographs and/or movies.

Another embodiment of the doll includes a transmitting mechanism for transmitting files from the doll onto a mobile device. Alternatively, the doll may be constructed such that a mobile device may access files stored in the doll.

In yet another embodiment of the invention, the doll includes a microphone for recording audio. The audio file is transferred to the mobile device, and then onto the server. The system preferably grants certain users access to files uploaded from the doll. The doll may include a button which, upon being pressed within a certain period of time after listening to a received message, initiates recording a message in reply thereto. The reply message is then uploaded onto the server via the mobile device and transmitted to the sender of the initial message, more preferably to their mobile device.

One embodiment of the invention includes a system requiring security access qualifications, such as a unique key, before granting users access to files associated with a specific toy corresponding to the key.

Another embodiment of the invention is directed to a system in which the mobile device receives data wirelessly from a server, for example, via WiFi or the mobile device's wireless data connection.

Still other objects and advantages of the invention will in part be obvious and will in part be apparent from the specification. Other features and advantages of this invention will become apparent in the following detailed description of exemplary embodiments of this invention with reference to the accompanying drawings.

### BRIEF DESCRIPTION OF THE DRAWINGS

For a fuller understanding of the invention, reference is made to the following description taken in connection with the accompanying drawing, in which:

FIG. 1 is a system in accordance with an embodiment of the invention;

FIG. 2 is a front view of an embodiment of a toy in accordance with an embodiment of the invention;

FIG. 3 is an alternate view of the embodiment of a toy of FIG. 2; and

FIG. 4 is a front view of an embodiment of a toy in accordance with an embodiment of the invention.

### DETAILED DESCRIPTION OF THE PREFERRED EMBODIMENTS

The invention generally is directed to a toy and a system for transferring data to and from the toy. The toy referred to herein may be a plush doll such as a teddy bear, a plastic robot, or any toy or device. The data may comprise, by way of non-limiting example, audio, image, video, and/or control data. The data is preferably transferred from a mobile device to the toy, the mobile device receiving the data from a remote server, preferably uploaded from a second device.

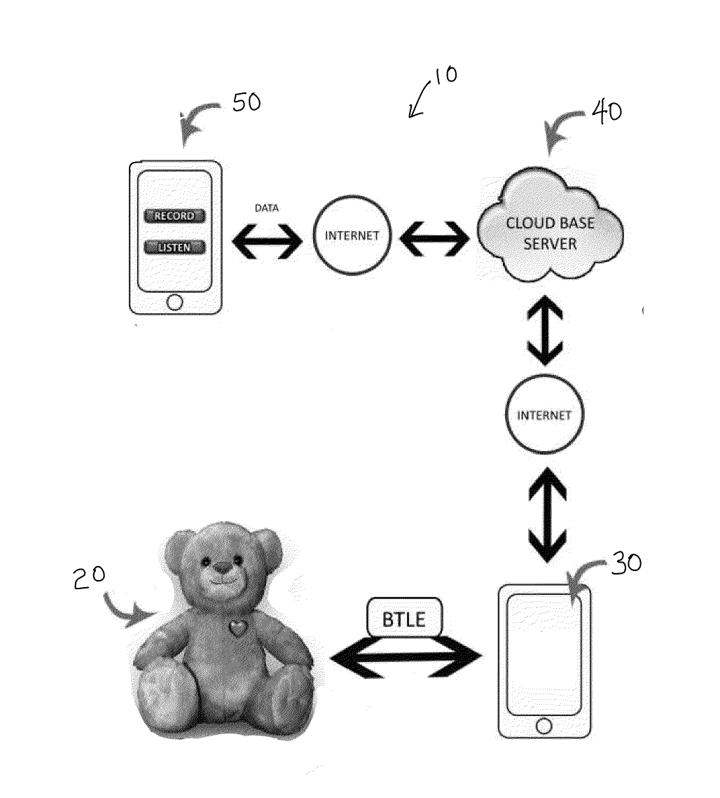

Reference is made to FIGS. 1-3, wherein a system 10 is illustrated having a toy 20, a first device 30, a server 40 and a second device 50. Generally, toy 20 and second device 50 communicate via server 40 and first device 30. More specifically, second device 50 is in data communication with server 40, which is in data communication with first device 30, which is in data communication with toy 20.

For example, a user, such as a grandmother, may record an audio message for her grandson from second device 50, such as a cell phone having a mobile application running. Preferably, the first time she starts the application, she will be prompted to enter an email address and password to create a new account. Thereafter, second device 50 may be associated to her account on server 40, so that she may upload files onto server 40 whenever she launches the application. Alternatively, she may be required to log into her account each time she launches the application. The user may connect to server 40 via second device 50's cellular data connection, WiFi or another system or device such as a computer which is connected to the Internet.

Once the user is logged into her account, she may choose which toy 20 to send her message to. For example, if the user has three grandchildren, each with a toy 20 linked to her account, she may choose to send her message to one of the three toys 20, to two of them or all three. She may then upload her message to server 40, which matches second device 50 with the appropriate toy 20. Preferably, server 40 has a folder for each toy 20, into which data for the respective toy 20 is saved. The user's message is saved in the folder for the specified toy 20, or otherwise associated with the specified toy 20.

In the embodiment shown, the user's message is then sent from server 40 to first device 30, preferably via first device's cellular data connection, WiFi, or any suitable data communication mechanism, more preferably via a mobile application installed on first device 30. The message is then sent from first device 30 to toy 20, either directly from first device 30 to toy 20 such as via Bluetooth, NFC, WiFi or other data communication mechanism. Preferably, the message is transferred via Bluetooth LE technology from first device 30 to toy 20. Once the message is saved onto toy 20, the recipient, such as the grandson, may play the message from his grandmother via toy 20.

Preferably, toy 20 and system 10 can accommodate large pieces of data, and thus the grandmother may read a book, a bedtime story, sing a lullaby, etc. for her grandson. The grandson may play the message from his toy 20 and read along, listen while in bed, etc. Such a system and toy may help family and friends stay in touch, especially with younger children who do not have cell phones, email accounts, etc. of their own. Toy 200 may also include a display screen 210 for displaying images, videos, text, etc. as illustrated in FIG. 4. The grandmother may record a video or take pictures with second device 50 and send to toy 200 via system 10 as described herein. System 10 and toy 200 may also be constructed so that a person on second device 50 can play a game with the grandson on toy 200, for example, on display screen 210.

Likewise, after listening to the message from his grandmother, the grandson may record a reply message for his grandmother directly from toy 20, 200 which is received by first device 30 via Bluetooth, uploaded from first device 30 to server 40, then downloaded onto second device 50 from which the grandmother may view or listen to the reply message from her grandson. Preferably, when a reply message is recorded on toy 20, toy 20 may associate the reply message with the most recent message received. Alternatively, after the reply message is uploaded onto server 40, server 40 identifies the most recent message transmitted to toy 20 and the second device 50 from which the message was received, and sends the reply message to second device 50. Alternatively, when a reply message is recorded on toy 20, it may be associated with data regarding the sender of the most recent message received by toy 20. Thus, once the reply message is received at server 40, it may identify which second device 50 to send the reply message to. Automatically identifying the recipient based on the most recent message received and sending the reply message may facilitate a young child recording and sending reply messages without the assistance of an adult. For example, toy 20 may include a play button 104 and a record button 106, so that the child can easily press play button 104 to play a received message, and press record button 106 to record a reply message for the sender. As long as toy 20 is within range of first device 30, the reply message may be automatically transmitted to first device 30, and to server 40.

A message may be recorded on toy 20 without being in a reply message to a received message. System 10 may specify a time limit, for example, one minute, five minutes, or any time limit desired, for automatically associating a reply message to information regarding the sender of the received message. For example, if a message is recorded on toy 20 within five minutes after listening to a received message, the message may be automatically associated with data regarding the sender of the received message, as described above. Likewise, if the message is recorded more than five minutes after listening to a received message, the mobile application on first device 30 may require that a recipient of that message is identified. Once the recipient is identified, data regarding the recipient may be associated with the message and transmitted to server 40. Preferably, the recipient has an account on server 40, and the message is sent to second device 50 of the recipient. Alternatively, the message may be sent to the recipient via email, text, or other messaging mechanism as a file or a link to the file on server 40.

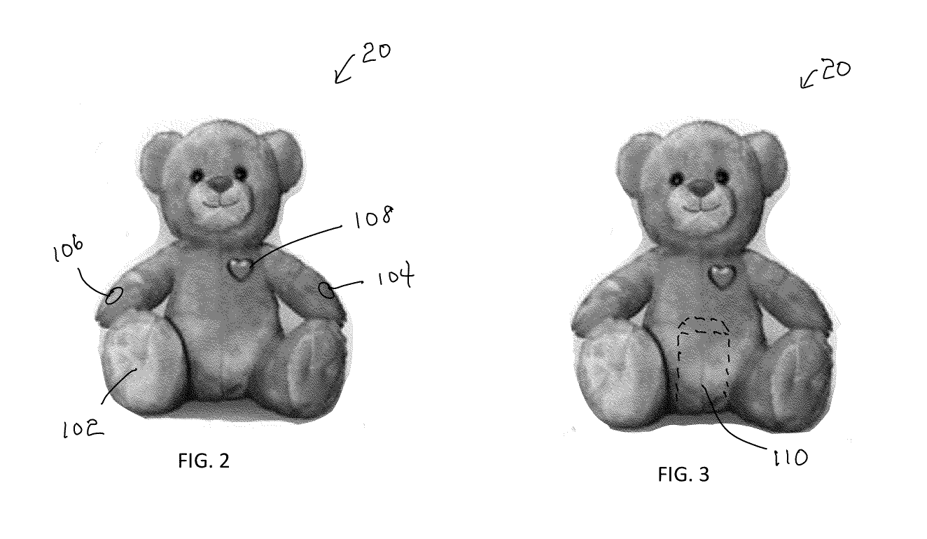

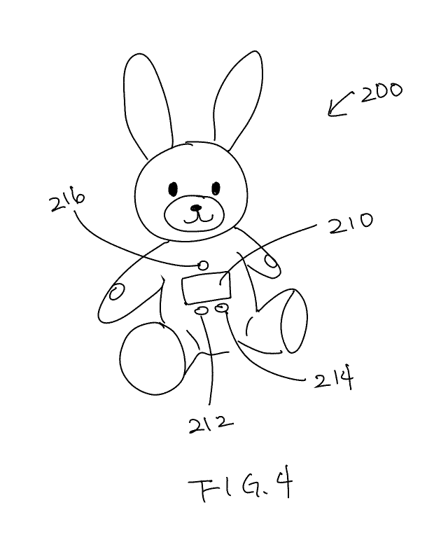

FIGS. 2-3 illustrate an embodiment of toy 20 having a body 102, play button 104, record button 106, an indicator 108, and a processing device 110. The embodiment of processing device 110 has a processor, more preferably a microprocessor to process data and information, a memory element for storing data, and a transmitter such as a Bluetooth communications radio, more preferably using Bluetooth LE (low energy) technology using Bluetooth 4.0 protocol, to send and receive data to/from first mobile device 30. The Bluetooth protocol may transmit user information, security key(s), and data between toy 20 and first device 30. Processing device 110 grants access to toy 20 to first device 30 having a matching key within data communication with toy 20.

Indicator 108 as shown indicates when a new file, such as an audio message, has been received by toy 20. Preferably, indicator 108 includes one or more light elements, for example, LEDs (light emitting diode) that lights up or flashes when there is a new message that has not been played. Indicator 108 may visually alert the child that he received a message, which he may listen to by pressing play button 104.

Toy 20 preferably also includes a media device for playing media files, such as audio and visual files, and a speaker via which the audio element, if any, of a file may be heard. More preferably, toy 20 further includes a microphone for recording a sound, for example a reply message. Therefore, after receiving a file having an audio element like an audio message, a child may play the message by pressing play button 104, upon which the message can be heard through the speaker. Play button 104 is preferably connected to processing device 110 by one or more wires inside of toy 20. The speaker may be a part of or separate from processing device 110. Preferably, the speaker is enclosed within processing device 110 or otherwise hidden within toy 20. More preferably, toy 20 is a plush doll with sufficient padding surrounding processing device 110 so that when a child hugs toy 20, toy 20 will feel soft and squeezable notwithstanding processing device 110. Toy 20 may be a plush doll having the form of an animal, such as a bear, cat, rabbit, etc. so that it may seem to a child that the doll is talking to him. For example, the speaker may be located proximate the mouth of the doll so that the doll may appear to be saying the message. The microphone may be located proximate the doll's ears, so that the doll may appear to hear the reply message being recorded. Play button 104 and record button 106 may be located on the paws of the plush doll, as shown in FIGS. 2-4, or otherwise easily accessible for a child.

A child or other user may record a message by pressing record button 106, which is preferably connected to processing device 110 by one or more wires inside of toy 20. Processing device 110 may be programed to associate the recording with the most recently received message, as described above. Therefore, the child may simply press record button 106 to send a response to the sender of the received message, without needing to enter recipient information, thus simplifying the process, especially for young children. Once record button 106 is pressed, the microphone of processing device 110 is activated, and sound is thus recorded and saved by processing device 110. Processing device 110 may be constructed and programmed to record for a predetermined duration, after which the microphone is deactivated. Alternatively, record button 106 may be pressed again to deactivate the microphone and cease recording, or other variations may be provided as a matter of application specific to design choice.

In the embodiment shown, processing device 110 includes a Bluetooth radio, and the file of the child's recording captured by processing device 110 is transmitted to or retrieved by first mobile device 30. The file transfer may occur automatically if first mobile device 30 is within range of toy 20, comes within range of toy 20, at predetermined times, or first mobile device 30 may be required to initiate transfer, to name a few options available. Preferably, a user, for example the child's parent, may choose when and how file transfers are to take place.

Processing device 110 is preferably battery operated, preferably by one or more standard batteries such as AA batteries. The batteries are preferably removable via the bottom of toy 20. Toy 20 may include a power switch for turning processing device 110 on and off, preferably on the bottom of toy 20 proximate the battery receiving portion.

The embodiment of toy 200 illustrated in FIG. 4 further includes a screen 210 for displaying visual elements of files received, by way of non-limiting example, photographs or videos. Alternatively, screen 210 may be used to play a game with someone playing on second device 50. Therefore, a child with toy 200 may play a game with a parent, grandparent, cousin, etc. in another part of the world, or exchange photographs, video messages, etc. Screen 210 may be a touch screen, and/or toy 200 may include control buttons 212, 214 to control display function of screen 210. Alternatively or in combination thereto, play button 104 and record button 106 may be utilized to control display screen 210, play games.

Whereas examples of toy 20, 200 are described herein as a plush doll, toy 20 may take any form or size without deviating from the scope of the invention, for example, a robot, a figurine, a ball, etc. Moreover, whereas a toy 20 is described as an exemplary embodiment, it is to be understood that it need not be a toy, but any other suitable device, without deviating from the scope of the invention. Non-limiting examples include portable items an article of clothing, a picture frame, a camera, handheld game player, a portable music player such as an mp3 player, or a piece of jewelry, and larger items such as a television, radio, game console, cable box, media streaming device such as Roku®, Slingbox®, etc.

Alternate embodiments of toy 20 may further comprise other devices, such as a video monitor, touch sensors, a digital camera, or a motor. These input and output devices are preferably controlled remotely through server 40.

First Device

First device 30 is preferably a mobile device, such as a cell phone, tablet, computer or other device having Bluetooth technology, an NFC (near field communication) technology or other technology that permits first device 30 to communicate data directly and wirelessly with toy 20 without the need for a network system. First device 30 may communicate with toy 20 via Bluetooth technology, wherein first device 30 is capable of transmitting or receiving data from toy 20 as long as it is within range, for example, within 40 feet of toy 20, more preferably within 20 feet, most preferably within 10 feet. Alternatively, a closer range may be required, for example, if NFC technology is used to transfer the data between first device 30 and toy 20. However, it is to be understood that first device 30 and toy 20 may communicate via a network system without deviating from the scope of the invention. For example, first device 30 may be a computer or any device with a transmitting means for communicating with toy 20 via a local network, such as via WiFi, a direct connection via a cable, etc. without deviating from the scope of the invention. It is to be understood that other technologies for data communication are contemplated without deviating from the scope of the invention.

First device 30 preferably includes an application, software or other mechanism to identify itself as an authorized device to access toy 20's data and to connect to toy 20 thereafter. For example, first device 30 may include a server API (application programming interface) for communicating with server 40. Thus, a stranger cannot use his cell phone to send inappropriate videos, images and the like to a child's toy 20. Likewise, a stranger cannot retrieve images, videos and the like from the child's toy 20.

In accordance with a preferred embodiment, first device 30 includes a mobile application for use on a mobile device. The application is required for first device 30 to communicate with toy 20. More preferably, first device 30 has a key or other identifying mechanism for accessing toy 20. In accordance with an embodiment, each toy 20 is assigned a unique key, which may be, by way of non-limiting example, a sequence of letters, numbers, or a combination thereof. In order for first device 30 to access toy 20, it must present that toy's unique key, preferably via an appropriate application. If the key from first device 30 matches the key of toy 20, first device 30 is granted access to toy 20 to transfer data to or from toy 20. Preferably, the same key grants access to portions of server 40 corresponding to the specific toy 20, by way of non-limiting example, all content associated with toy 20 or in the folder for toy 20, etc. It is to be understood that a different key, code, log in information, or any other suitable authorization means may be utilized without deviating from the scope of the invention.

Preferably, a user may view a message on first device 30 prior to transmitting it to server 40 or toy 20, for example, to screen it for inappropriate content. More preferably, the user may delete any unwanted content received with or without transmitting same to toy 20 or server 40.

Additionally, first device 30 preferably is capable of connecting to server 40 via the Internet. For example, first device 30 may connect via its cellular service provider, via WiFi, etc. to connect to the Internet to access server 40. Upon connecting to server 40, first device 30 may retrieve or transmit data for toy 30 for which it holds a key.

Second Device

Second device 50 may be a mobile device, such as a cell phone or tablet, or a computer or any device that can connect to server 40 via the Internet, intranet, or other network means. Preferably, second device 50 has a microphone for recording audio, a camera for capturing images, and/or both for recording video with sound. Therefore, after recording or capturing the audio, image or video, a user may transmit such data to server 40 to be transmitted to first device 30 and ultimately to toy 20. Second device 50 does not need to be the device that captures the content, but rather, the content may be transmitted from the content-capturing device to second device 50. For example, content may be captured using a camera, and then saved onto a computer, from which the content is uploaded onto server 40. A user may transfer the content to a cell phone and upload from the cell phone.

Second device 50 may be required to have a key saved within second device 50 in order to transmit content to server 40 or to have such content be associated with the specified toy 20. Alternatively, second device 50 may be required to enter a code unique for each toy 20, via a mobile application or on a website. In yet another embodiment, the user who sets up the account for toy 20 identifies a list of people who may send files to toy 20, by submitting email addresses, phone numbers, or any other suitable identifying information to server 40.

Other alterations may be made without deviating from the scope of the invention. Accordingly, the system and method, the use, steps, order of steps, etc. may be varied as a matter of application specific design choice without deviating from the scope of the invention. For example, whereas the sender of the message to the toy has been described herein as a relative, it is to be understood that anyone may send a message to the toy. Also, whereas the examples provided require a key or other identification and authorization at the second device's end, an embodiment may permit anyone to upload content to the toy's folder on the server by entering the toy's user ID, email address or other toy identifying element. The first device may receive an alert that new content had been uploaded, and the parent or whoever is at the first device may choose whether or not to download the content. The system may permit the parent to set up a list of users, for example by user ID or email address, whose content will be automatically downloaded and transmitted to the toy without the parent downloading the content each time.

Moreover, data may be transmitted between the first or second device and the server via any means for data transmission, and is not limited to wireless transmissions described herein. For example, any device connected to the Internet by any means may send or receive the messages. It is the intention, therefore, to be limited only as indicated by the scope of the claims appended hereto.

It is also to be understood that the following claims are intended to cover all of the generic and specific features of the invention herein described and all statements of the scope of the invention which, as a matter of language, might be said to fall there between.

We claim:

1. A plush doll comprising:
a body;
a speaker;
an antenna for receiving a data transmission wirelessly from a mobile device;
a storage medium for storing said data transmission;
a processor for processing said data transmission; and
a media device for playing media files.

2. The doll of claim 1, wherein the antenna comprises a Bluetooth low energy chip to connect via Bluetooth to a Bluetooth-enabled device.

3. The doll of claim 1, wherein the antenna comprises a near-field communication chip to connect via near-field communication a near-field-communication-enabled device.

4. The doll of claim 1, further comprising a screen for displaying images, wherein said media device is constructed and arranged to play video files.

5. The doll of claim 1, further comprising a recording device for capturing media content.

6. The doll of claim 5, wherein said recording device comprises a microphone.

7. The doll of claim 5, wherein said recording device comprises a camera.

8. The doll of claim 5, wherein the processor extracts a sender's data from said data transmission and associates said sender's data to said media content as a recipient of said media content.

9. The doll of claim 1, wherein said body is a soft body of a plush doll.

10. A system for data transmission between a server and a toy, the system comprising:
a toy comprising
an antenna for receiving a data transmission wirelessly from a device,
a storage medium for storing said data transmission,
a toy processor for processing said data transmission, and
a media device for playing media files;
a server comprising
a database including information regarding a plurality of toys,
a server processor for processing data received, identifying a sender transmitting said data and said toy to which said data is to be transmitted,
said server receiving data from said sender and transmitting said data to said device for transmittal to said toy.

11. The system of claim 10, wherein said device is a mobile device.

12. The system of claim 10, wherein said antenna comprises a Bluetooth low energy chip to connect via Bluetooth to a Bluetooth-enabled device, and said device is a Bluetooth-enabled device.

13. The system of claim 10, wherein said antenna comprises a near-field communication chip to connect via near-field communication a near-field-communication-enabled device, and said device is a near-field-communication-enabled device.

14. The system of claim 10, wherein said data transmission comprises a first media content.

15. The system of claim 10, wherein the server receives a second data transmission from said device, said second data transmission comprising a second media content recorded on said toy.

16. The system of claim 15, wherein the server identifies said sender of said data transmission and transmits said second data transmission to said sender.

17. The system of claim 15, wherein said toy processor extracts a sender data from said data transmission received by said toy, and associates said sender data to said second data transmission.

18. The system of claim 10, wherein said database includes information on a plurality of senders.

19. The system of claim 10, wherein said server requires an authorization key from said sender prior to transmitting said data transmission to said device.

20. The system of claim 10, wherein said device receives said data transmission from said server via a mobile application.
